(19) United States
(12) Patent Application Publication
(10) Pub. No.: US 2025/0273192 A1
(43) Pub. Date: Aug. 28, 2025

(54) AUDIO OUTPUT DEVICE

(71) Applicant: PIONEER CORPORATION, Tokyo (JP)

(72) Inventor: Yusuke OKADA, Kawagoe-shi, Saitama (JP)

(21) Appl. No.: 18/687,223

(22) PCT Filed: Sep. 26, 2022
(86) PCT No.: PCT/JP2022/035619

§ 371 Date: Aug. 5, 2024

(30) Foreign Application Priority Data
Sep. 30, 2021 (JP) 2021-160742

(51) Int. Cl. G10K 15/04; G06F 3/16

(52) U.S. Cl. CPC G10K 15/04; G06F 3/165

(57) ABSTRACT

An audio output device and associated output method produce sound effects that are more natural to a listener are given to a piece of music. A mode is selected from a plurality of modes, and first sound source data and second sound source data are respectively outputted as the sound effects with music data at an output level that is determined based on the mode selected by a mode selection unit.

### TECHNICAL FIELD

The present invention relates to an audio output device.

### BACKGROUND ART

A technique that gives sound effects to a piece of music and causes an atmosphere of a live concert venue to be experienced has been known. For example, in Patent Document 1, a karaoke sound effects system is disclosed, and in this karaoke sound effects setting system, a type of the sound effects is set according to a genre of the piece of music, and an output mode (the number of people that clap or give a cheer) of the sound effects is set according to a size of the selected live concert venue.

### CITATION LIST

### Patent Literature

[Patent Document 1]: JP 2016-70999 A

### SUMMARY OF THE INVENTION

A sound or volume of a cheer or a clap by an audience or the like changes depending on a size of the audience or a size of a venue. Then, by preparing sound source data by the size of the audience or the size of the venue and changing the sound source data used as sound effects according to a piece of music, it becomes possible to cause a listener to experience an atmosphere of being at a live concert venue more. However, in a case where the sound source data are prepared by the size of the audience or the size of the venue, a storage device with a large capacity is required to store these sound source data. The Patent Document 1 does not disclose a technique to solve the problem described above.

An example of the problems to be solved by the present invention is to give sound effects that are more natural to a listener to a piece of music while suppressing load to a storage device.

### SOLUTION OF THE PROBLEM

In order to achieve the objective described above, the invention described in claim 1 includes: a mode selection unit selecting a mode from a plurality of modes; and an audio output unit outputting first sound source data and second sound source data as sound effects with music data, in which each of an output level of the first sound source data and an output level of the second sound source data is determined based on the selected mode.

The invention according to claim 8 relates to an audio output method performed by a computer, the audio output method including; a mode selection step of selecting a mode from a plurality of modes; and an audio output step of outputting first sound source data and second sound source data as sound effects with music data.

The invention according to claim 9 relates to a sound output program that causes a computer to perform the audio output method according to claim 8.

The invention according to claim 10 stores the sound output program according to claim 9.

### BRIEF DESCRIPTION OF DRAWINGS

FIG. 1 shows a sound effects mixing device 100 according to an example of the present invention.

FIG. 2 is a diagram illustrating an example of an output of music by a music output unit 120 and an output of sound effects by a sound effects output unit 130.

FIG. 3 is a chart indicating an example of a processing operation in a sound effects mixing device 100 according to an example of the present invention.

FIG. 4 is a diagram illustrating an example of an output of music by a music output unit 120 and an output of sound effects by a sound effects output unit 130.

FIG. 5 is a chart indicating an example of a processing operation in a sound effects mixing device 100 according to an example of the present invention.

### DESCRIPTION OF EMBODIMENTS

An audio output device according to an embodiment of the present invention includes: a mode selection unit selecting a mode from a plurality of modes; and an audio output unit outputting first sound source data and second sound source data as sound effects with music data, in which each of an output level of the first sound source data and an output level of the second sound source data is determined based on the selected mode. Therefore, in the present embodiment, by adjusting the output level of the first sound source data and the output level of the second sound source data, it is possible to mix the sound effects of various sizes of audiences or various sizes of venues into a piece of music. As a result, in the present embodiment, the sound effects that are more natural to a listener can be given to the piece of music by small sound source data, and it becomes possible to cause the listener to experience an atmosphere of being at a live concert venue more.

The first sound source data may include a sound generated by a large number of people, and/or a sound generated in a first region. Further, the second sound source data may include a sound generated by a small number of people, and/or a sound generated in a second region that is more separated from a reference position than the first region. By doing this way, it is possible to mix the sound effects various sizes of audiences or the various sizes of venues into the piece of music by the small sound source data.

The plurality of modes may include a plurality of types of modes, each of the plurality of types of modes corresponding to a different size of an audience and/or a different size of a venue. Thus, in the present embodiment, it becomes possible to give sound effects according to a size of the audience or a scale of the venue to the piece of music.

The sound effects may include at least one of a sound in linkage with a sound of a cheer, a sound of a clap, an environmental sound constantly generated at the venue, rhythm of the piece of music, and a beat of the piece of music. Thus, it becomes possible to give the cheer, the sound of a clap, the environmental sound, and a hand clap, that is appropriate for various sizes of the audience or various sizes of the venue to the piece of music by the small sound source data.

There may be a plurality of types of first sound source data, and the first sound source data that is outputted may be randomly selected from the plurality of types of first sound source data. In addition, there may be a plurality of types of second sound source data, and the second sound source data that is outputted may be randomly selected from the plurality of types of second sound source data. Thus, the sound effects outputted from a sound effects output unit will not be monotonous, and as a result, the sound effects that are more natural to the listener can be given to the piece of music, and it becomes possible to cause the listener to experience the atmosphere of being at the live concert venue more.

Further, an audio output method according to an embodiment of the present invention is an audio output method performed by a computer, the audio output method including: a mode selection step of selecting the mode from the plurality of modes; and an audio output step of outputting the first sound source data and the second sound source data as the sound effects with the music data. Therefore, in the present embodiment, by adjusting the output level of the first sound source data and the output level of the second sound source data, it is possible to mix the sound effects various sizes of audiences or various sizes of the venue into the piece of music. As a result, in the present embodiment, the sound effects that are more natural to the listener can be given to the piece of music by the small sound source data, and it becomes possible to cause the listener to experience the atmosphere of being at the live concert venue more.

In addition, a sound output program according to an embodiment of the present invention causes the computer to execute the audio output method described above. Thus, it becomes possible to cause the listener to experience the atmosphere of being at the live concert venue more by using the computer.

Further, a computer-readable storage medium according to an embodiment of the present invention stores the sound output program described above. In this way, in addition to being incorporated into a device, the sound output program described above can be distributed alone, and it becomes possible to perform version upgrades or the like easily.

### EXAMPLE

### Sound Effects Mixing Device 100

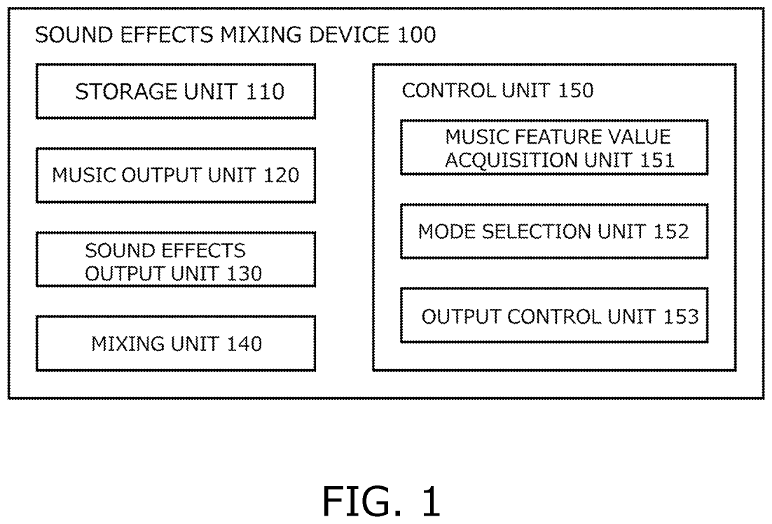

FIG. 1 is a sound effects mixing device 100 according to an example of the present invention. The sound effects mixing device 100 mixes (gives) sound effects into (to) a piece of music and outputs the piece of music such that a listener can experience an atmosphere that causes the listener to feel like listening to the piece of music at a live concert venue. Then, the sound effects mixing device 100 includes a storage unit 110 that stores data of the piece of music or sound source data for the sound effects or the like, a music output unit 120 that outputs the piece of music, a sound effects output unit 130 that outputs the sound effects, and a mixing unit 140 that mixes the sound effects outputted from the sound effects output unit 130 into the piece of music outputted from the music output unit 120. A sound of the piece of music into which the sound effects are mixed by the mixing unit 140 is outputted from an audio output apparatus such as a speaker. The sound effects mixing device 100 is an example of the audio output device according to the embodiment described above.

The storage unit 110 stores the data of the piece of music or the sound source data for the sound effects. The storage unit 110 is a storage device such as a hard disk or a flash memory.

The music output unit 120 outputs the piece of music. The music output unit 120 acquires data of the piece of music stored in, for example, the storage unit 110 or a compact disc (CD), or on the cloud, generates a signal of the piece of music from this acquired data, and outputs the generated signal of the piece of music.

The sound effects output unit 130 outputs the sound effects. The sound effects output unit 130 acquires the sound source data for the sound effects stored in, for example, the storage unit 110, and generates a signal of the sound effects from this acquired sound source data, and outputs the signal of the generated sound effects.

As the sound effects, there are a first sound effect such as a cheer or a clap generated at the beginning or the end of the piece of music at a live concert venue, a second sound effect such as an environmental sound (buzz) that is constantly generated at the live concert venue or the like, and a third sound effect such as a hand clap that is performed along with rhythm or a beat of the piece of music at the live concert venue or the like.

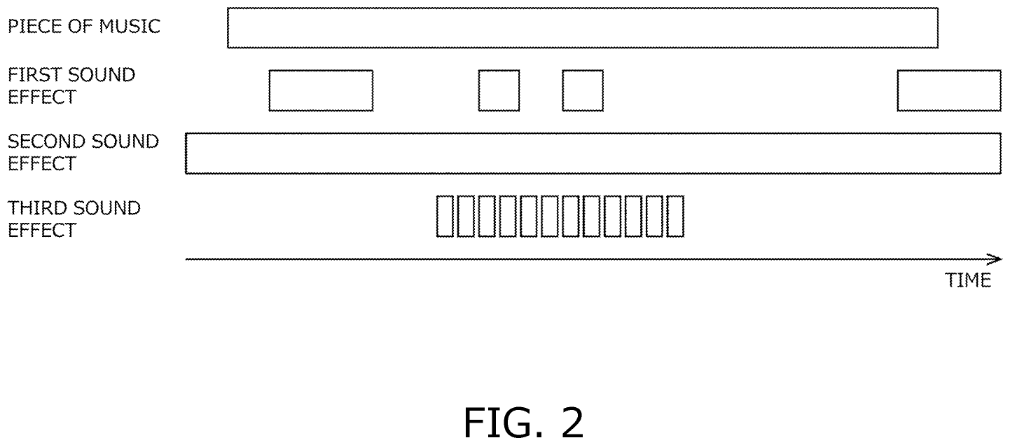

FIG. 2 is a diagram illustrating an example of an output of the piece of music by the music output unit 120 and an output of the sound effects by the sound effects output unit 130. In the example shown in FIG. 2, the first sound effect (cheer or clap or the like) is given to the midst of the piece of music or to the beginning and the ending portion of the piece of music. The second sound effect (environmental sound) is started to be outputted before an output of the piece of music is started, and is constantly outputted while the piece of music is being reproduced. The third sound effect (hand clap or the like) is outputted being synchronized with a beat or a tempo of the piece of music while the piece of music is being outputted as described below.

The mixing unit 140 mixes the sound effects outputted from the sound effects output unit 130 into the piece of music outputted from the music output unit 120, and outputs the piece of music having the sound effects being mixed in. The mixing unit 140 is, for example, a device that adds a plurality of signals and outputs an added signal, adds the signal of the piece of music outputted from the music output unit 120 and the signal of the sound effects outputted from the sound effects output unit 130, and outputs the added signal.

In addition, the sound effects mixing device 100 includes a control unit 150 that controls an output of the piece of music from the music output unit 120 and an output of the sound effects from the sound effects output unit 130. The control unit 150 is configured of a computer that includes a central processing unit (CPU) or the like.

The control unit 150 includes, for example, a music feature value acquisition unit 151 that acquires a feature value of the piece of music, a mode selection unit 152 that selects a mode out of a plurality of modes regarding a tone or a genre of the piece of music and a size of the live concert venue or the like, and an output control unit 153 that controls the output of the piece of music from the music output unit 120 and the output of the sound effects from the sound effects output unit 130 based on the feature value of the piece of music acquired by the music feature value acquisition unit 151 or the mode selected by the mode selection unit 152.

The music feature value acquisition unit 151 acquires the feature value of the piece of music. The feature value of the piece of music is, for example, sound volume of the piece of music, a position of a beat of the piece of music, the number of beats per unit time (for example, beats per minute (BPM)), a degree of clearness of the beat of the piece of music, a degree of equality of a sound volume level at the position of the beat of the piece of music, the number of types of chords used in the piece of music, the number of the chords per unit time, a degree of clearness of the chord, a power of each band, and a position of a chorus of the piece of music or the like.

The music feature value acquisition unit 151 may acquire the feature value of the piece of music by analyzing the piece of music, or, by causing the feature value of the piece of music acquired by the analysis that is performed in advance to be stored in the storage unit 110 or on the cloud, the music feature value acquisition unit 151 may acquire the feature value of the piece of music stored in the storage unit 110 or on the cloud. Further, the music feature value acquisition unit 151 may acquire the feature value of the piece of music from tag information that is given to the data of the piece of music stored in the storage unit 110 or a CD or the like.

For example, the output control unit 153 may preferably control the sound volume of the sound effects outputted from the sound effects output unit 130 based on the sound volume of the piece of music acquired by the music feature value acquisition unit 151. In this way, since it becomes possible to prevent the sound volume of the sound effects that are mixed in from getting too loud or too small in comparison with the sound volume of the piece of music, sound effects that are more natural to the listener can be given to the piece of music, and it becomes possible to cause the listener to experience an atmosphere of being at the live concert venue more. Further, the output control unit 153 may detect the tone of the piece of music based on the feature value of the piece of music acquired by the music feature value acquisition unit 151, and control the sound volume of the sound effects outputted from the sound effects output unit 130 based on this detected tone.

Further, the output control unit 153 may detect a level or the tone of the piece of music based on the feature value of the piece of music acquired by the music feature value acquisition unit 151, and control the output of the sound effects from the sound effects output unit 130 based on the detected level or tone. At this time, for example, the storage unit 110 may store the sound effects by the level or the tone of the piece of music, and the output control unit 153 may output the sound effects based on the detected level or tone. In addition, for example, the storage unit 110 may store the sound effects for a large scale venue such as a stadium or a venue of an outdoor festival, and an arena or the like, the sound effects for a middle-sized venue such as a hall or a middle or large-sized live concert music club or the like, and the sound effects for a small-sized venue such as a small-sized live concert music club or a music bar or the like, and the output control unit 153 may determine which to select out of the sound effects for the large scale venue, the sound effects for the middle-sized venue, and the sound effects for the small-sized venue as the sound effects outputted from the sound effects output unit 130 based on the detected tone. Thus, the sound effects that match the piece of music are given thereto, and it becomes possible to output the sound effects that are more natural according to the piece of music. As a result, the sound effects that are more natural to the listener can be given to the piece of music, and it becomes possible to cause the listener to experience the atmosphere of being at the live concert venue more.

The mode selection unit 152 selects a mode out of the plurality of modes regarding the tone or the genre of the piece of music and the size of the live concert venue or the like. At this time, the mode selection unit 152 may select the mode based on an input of a user or select the mode based on the feature value of the piece of music or the tag information of the piece of music.

For example, the mode prepared for each size of the live concert venue may be included in the plurality of modes. For example, the mode for the large scale venue, the mode for the middle-sized venue, and the mode for the small-sized venue may preferably be prepared. Then, the output control unit 153 may determine the sound effects to be outputted from the sound effects output unit 130 based on the mode selected by the mode selection unit 152 (that is, for example, in a case where the mode for the large scale venue is selected, the sound effects for the large scale venue are selected as the sound effects to be outputted), and control these determined sound effects to be outputted from the sound effects output unit 130. Thus, the sound effects that match the piece of music are given thereto, and it becomes possible to output the sound effects that are more natural according to the piece of music. As a result, the sound effects that are more natural to the listener can be given to the piece of music, and it becomes possible to cause the listener to experience the atmosphere of being at the live concert venue more.

For example, a mode prepared for each tone or each genre may be included in the plurality of modes. For example, a mode for upbeat music, a mode for slow music, a mode for classical music, and a mode for jazz or the like may be prepared. Then, the storage unit 110 may store the sound effects for each mode, and the output control unit 153 may determine the sound effects to be outputted from the sound effects output unit 130 based on the mode selected by the mode selection unit 152 (that is, in a case where the mode for the upbeat music is selected, the sound effects for the upbeat music is selected as the sound effects to be outputted), and control these determined sound effects to be outputted from the sound effects output unit 130. Thus, the sound effects that match the piece of music are given thereto, and it becomes possible to output the sound effects that are more natural according to the piece of music. As a result, the sound effects that are more natural to the listener can be given to the piece of music, and it becomes possible to cause the listener to experience the atmosphere of being at the live concert venue more.

### Processing Operation in Sound Effects Mixing Device 100

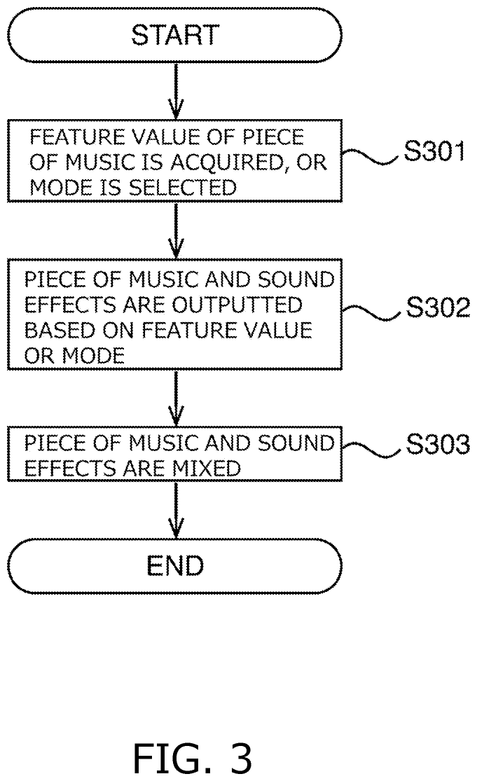

FIG. 3 is a chart indicating an example of a processing operation in the sound effects mixing device 100 according to the present example. The music feature value acquisition unit 151 acquires the feature value of the piece of music, or the mode selection unit 152 selects the mode (step S301). The output control unit 153 outputs the piece of music by the music output unit 120 and outputs the sound effects by the sound effects output unit 130 based on the acquired feature value or the selected mode (step S302). The mixing unit 140 mixes the sound effects outputted from the sound effects output unit 130 into the piece of music outputted from the music output unit 120 (step S303).

### Output of Sound Effects by Sound Effects Output Unit 130

A sound or volume of the cheer or the clap by an audience, the environmental sound, and the hand clap or the like change depending on a size of the audience or a scale of the venue. Then, by preparing the sound source data by the size of the audience or the scale of the venue and changing the sound source data used as the sound effects according to the piece of music, it becomes possible to cause the listener to experience the atmosphere of being at the live concert venue more. However, in a case where the sound source data is prepared by the size of the audience or the scale of the venue, the storage device with a large capacity is required to store these pieces of sound source data.

Then, in the sound effects mixing device 100 according to the present example, the sound effects are outputted by mixing a plurality of pieces of sound source data. Specifically, in the present example, the output control unit 153 simultaneously outputs first sound source data and second sound source data as the sound effects by the sound effects output unit 130. Then, at this time, the output control unit 153 determines an output level of the first sound source data and an output level of the second sound source data based on, for example, the mode selected by the mode selection unit 152.

At this time, the output control unit 153 may output the sound source data for a large number of people including a sound generated by the large number of people by the sound effects output unit 130 as the first sound source data, and output the sound source data for a small number of people including a sound generated by the small number of people as the second sound source data. Then, the output control unit 153 may determine the output level of the sound source data for the large number of people that is outputted and the output level of the sound source data for the large number of people that is outputted based on, for example, the mode selected by the mode selection unit 152. In this case, the plurality of modes may include the plurality of modes each corresponding to a different size of the audience (mode for large number of people or mode for small number of people) or the plurality of modes each corresponding to a different scale of the venue (mode for large-sized venue or mode for middle-sized venue, mode for small-sized venue).

Thus, it becomes possible to mix the sound effects of various sizes of audiences or various sizes of venue into the piece of music by small sound source data. As a result, the sound effects that are more natural to the listener can be given to the piece of music by the small sound source data, and it becomes possible to cause the listener to experience the atmosphere of being at the live concert venue more.

In addition, by the sound effects output unit 130, the output control unit 153 may output the sound source data for a vicinity sound including a sound generated in a vicinity (first region) of a reference position as the first sound source data, and output the sound source data for a distant sound including a sound generated at a position that is farther than the reference position (second region that is located farther from reference position than first region) as the second sound source data. Then, the output control unit 153 may determine the output level of the sound source data for the vicinity sound to be outputted and the output level of the sound source data for the distant sound to be outputted based on, for example, the mode selected by the mode selection unit 152. Here, the reference position is, for example, a position of the audience at the live concert venue. Further, the reference position may be a position of a stage of the live concert venue.

Thus, it becomes possible to mix the sound effects that are appropriate for the venue with various scales into the piece of music. For example, by making the output level of the sound source data for the distant sound approximately the same as the output level of the sound source data for the vicinity sound, both of the cheer or the clap that is generated in the vicinity and the cheer or the clap that is generated in the distance are given to the piece of music, and it becomes possible for the listener to experience the atmosphere in which the piece of music is played in a large scale live concert venue. Further, by making the output of the output level of the sound source data for the distant sound zero, only the cheer or the clap generated in the vicinity are given to the piece of music, and it becomes possible for the listener to experience the atmosphere in which the piece of music is played in a small-sized live concert venue. As a result, the sound effects that are more natural to the listener can be given to the piece of music by the small sound source data, and it becomes possible to cause the listener to experience the atmosphere of being at the live concert venue more.

The output control unit 153 may output the sound source data for the large number of people as the first sound effect, and output the sound source data for the distant sound as the second sound effect. In addition, the output control unit 153 may output the sound source data for the distant sound as the first sound effect, and output the sound source data for the small number of people as the second sound effect.

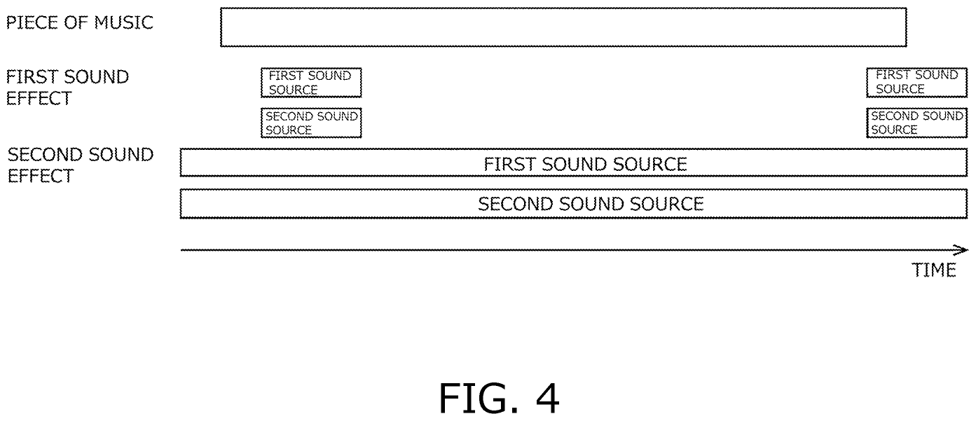

The sound effects in which the first sound source data and the second sound source data are prepared may be the first sound effect (cheer, clap or the like), the second sound effect (environmental sound), or the third sound effect (hand clap or the like). For example, in the example shown in FIG. 4, the first sound source data and the second sound source data are outputted with respect to the first sound effect and the second sound effect.

Further, the storage unit 110 may store a plurality of types of sound source data as the first sound source data, and the output control unit 153 may randomly select the first sound source data outputted from the sound effects output unit 130 from the plurality of Similarly, the storage unit 110 may store the plurality of types of sound source data. types of sound source data as the second sound source data, and the output control unit 153 may randomly select the second sound source data outputted from the sound effects output unit 130 from the plurality of types of sound source data. Thus, the sound effects outputted from the sound effects output unit 130 is no longer monotonous, and as a result, the sound effects that are more natural to the listener can be given to the piece of music, and it becomes possible to cause the listener to experience the atmosphere of being at the live concert venue more.

Further the storage unit 110 may store the sound source data for reverberation, and the output control unit 153 may output the sound source data for the reverberation in addition to the first sound effect and the second sound effect. Thus, the sound effects given to the piece of music becomes a sound that is close to a sound generated in the live concert venue, and as a result, the sound effects that are more natural to the listener can be given to the piece of music, and it becomes possible to cause the listener to experience the atmosphere of being at the live concert venue more.

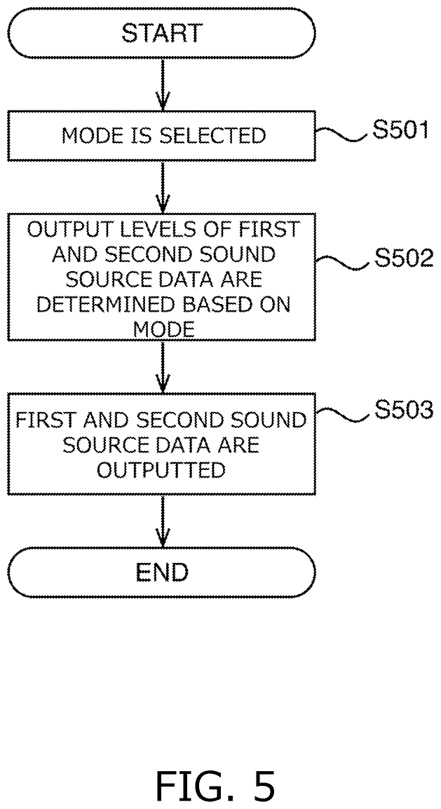

FIG. 5 is a chart indicating an example of the processing operation in the sound effects mixing device 100 according to the present example. The mode selection unit 152 selects the mode (step S501). The output control unit 153 determines the output level of the first sound source data and the output level of the second sound source data based on the selected mode (step S502), and outputs the first sound source data and the second sound source data at this determined output level by a sound effects output unit 120 (step S503).

In addition, in the example described above, the sound effects that are appropriate for the size of the audience or the scale of the venue are outputted by changing the output level of each of the plurality of sound source data, however, by changing the output level of each of the plurality of sound source data, the sound effects that are appropriate for other characteristics of the venue (shape of venue or the like) may be made capable of being outputted.

The present invention has been described above with reference to preferred embodiments of the present invention. Although the present invention has been described with reference to specific examples, various modifications and changes can be made to these specific examples without departing from the spirit and scope of the present invention specified in the claims.

### Reference Signs List

100 Sound effects mixing device
110 Storage unit
120 Music output unit
130 Sound effects output unit
140 Mixing unit
150 Control unit
151 Music feature value acquisition unit
152 Mode selection unit
153 Output control unit

1. An audio output device comprising:
a mode selection unit selecting a mode from a plurality of modes; and
an audio output unit outputting first sound source data and second sound source data as sound effects with music data,
wherein each of an output level of the first sound source data and an output level of the second sound source data is determined based on the selected mode, and
wherein the first sound source data comprises a sound generated by a large number of people, and/or a sound generated in a first region.

2. (canceled)

3. The audio output device according to claim 1,
wherein the second sound source data comprises a sound generated by a small number of people, and/or a sound generated in a second region that is more separated from a reference position than the first region.

4. The audio output device according to claim 1,
wherein the plurality of modes comprise a plurality of types of modes, each of the plurality of types of modes corresponding to a different size of an audience and/or a different size of a venue.

5. The audio output device according to claim 1,
wherein the sound effects comprise at least one of a sound in linkage with a sound of a cheer, a sound of a clap, an environmental sound constantly generated at the venue, rhythm of the piece of music, and a beat of the piece of music.

6. The audio output device according to claim 1,
wherein there are a plurality of types of first sound source data, and
wherein the first sound source data to be outputted is randomly selected from the plurality of types of first sound source data.

7. The audio output device according to claim 1,
wherein there are a plurality of types of second sound source data, and
wherein the second sound source data to be outputted is randomly selected from the plurality of types of second sound source data.

8. An audio output method executed by a computer comprising:
a mode selection step of selecting a mode from a plurality of modes; and
an audio output step of outputting first sound source data and second sound source data as sound effects with music data,
wherein each of an output level of the first sound source data and an output level of the second sound source data is determined based on the selected mode, and
wherein the first sound source data comprises a sound generated by a large number of people, and/or a sound generated in a first region.

9. (canceled)

10. A computer-readable storage medium storing a sound output program configured to cause a computer to execute the audio output method according to claim 8.
